(19) United States
(12) Patent Application Publication
(10) Pub. No.: US 2006/0161963 A1
(43) Pub. Date: Jul. 20, 2006

(54) Display apparatus and control method thereof

(75) Inventors: Yun-ju Hong, Suwon-si (KR); Young-chan Kim, Uiwang-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/316,917

(22) Filed: Dec. 27, 2005

(30) Foreign Application Priority Data
Jan. 17, 2005 (KR) 2005-0004233

(51) Int. Cl. H04N 5/44; H04N 7/173; H04N 7/16

(52) U.S. Cl. 725/134; 348/725; 725/131; 725/100; 725/142

(57) ABSTRACT

A display apparatus comprises an interface to receive a signal from an external source, and operates either in a digital packet video link (DPVL) mode or in a raster video mode. The display apparatus decodes data of the signal input through the interface, determines whether the signal is a DPVL signal on the basis of the decoded data, and operates in the DPVL mode when the signal is determined as the DPVL signal or in the raster video mode when the signal is not determined as the DPVL signal. A display apparatus and a control method thereof determine whether input data is the DPVL signal on the basis of decoded results of the input data, thereby displaying a picture normally even based on an abnormal DPVL signal.

### CROSS-REFERENCE TO RELATED APPLICATIONS

This application claims the benefit under 35 U.S.C. §119 from Korean Patent Application No. 2005-0004233, filed on Jan. 17, 2005, in the Korean Intellectual Property Office, the entire disclosure of which is hereby incorporated by reference.

### BACKGROUND OF THE INVENTION

1. Field of the Invention

The present invention relates to a display apparatus and a control method thereof. More particularly, the present invention relates to a display apparatus and a control method thereof, in which the display apparatus supports a digital packet video link (DPVL) mode in which the amount of video data according to DPVL standards is minimized to enhance transmission speed.

2. Description of the Related Art

With recent developments in the technology of manufacturing a display apparatus, the density, the number and the like, of pixels provided in the display apparatus have increased. Accordingly, the amount of video data has also increased, and thus various methods have been proposed to reduce the amount of video data in order to effectively process a large amount of video data.

As an example of the proposed methods, DPVL standards are proposed by video electronics standard associations (VESA).

According to the DPVL standards, an external source transmits information about a current frame and varied data of the video data to the display apparatus in order to reduce the amount of data to be transmitted. When the display apparatus receives a DPVL signal, the display apparatus partially changes video data stored in a current frame buffer in correspondence to only the varied data transmitted from the external source, and then displays a picture based on the total frame data. Thus, the amount of data to be processed can be decreased.

The display apparatus supporting the DPVL standards determines whether an input video signal is a DPVL signal or not, and then operates in a DPVL mode when the input video signal is a DPVL signal.

FIG. 1 is a control flowchart showing a conventional manner of determining whether an input video signal is a DPVL signal or a raster video signal in a conventional display apparatus supporting the DPVL standards.

As shown in FIG. 1, at operation 110, the display apparatus supporting the DPVL standards determines whether the input video signal satisfies the following conditions: V sync width≦2H sync, and VBP 5H≦sync. In other words, when the input video signal has the width of a vertical synchronous signal that is equal to or smaller than a period corresponding to two horizontal lines, and a vertical back porch signal is equal to or smaller than a period corresponding to five horizontal lines, this frame data is determined as the DPVL signal.

When the input video signal is determined to be a DPVL signal, at operation 111, the display apparatus operates in the DPVL mode. Otherwise, at operation 113, the display apparatus operates in the raster video mode.

However, when the input video signal is an abnormal DPVL signal, the display apparatus may operate in the raster video mode even though the input video signal is a DPVL signal. Further, even though the input video signal is a DPVL signal, the display apparatus may not be able to recognize that the input video signal is a DPVL signal because of a noise or the like included in the input video signal.

### SUMMARY OF THE INVENTION

Accordingly, an aspect of the present invention is to provide a display apparatus and a control method thereof, which determine whether input data is a DPVL signal on the basis of decoded results of the input data, thereby normally displaying a picture based on an abnormal DPVL signal.

Additional exemplary aspects and/or advantages of the present invention will be set forth in part in the description which follows and, in part, will be understood from the description by artisans skilled in the art of display apparatus.

The foregoing and/or other exemplary aspects of the present invention are achieved by providing a display apparatus comprising an interface to receive a signal from an external source, and either operating in a DPVL mode or a raster video mode. The display apparatus comprises a decoder to decode data of the signal input through the interface, and a display controller to determine whether the signal is a DPVL signal on the basis of the decoded data. The display controller controls the display apparatus to operate either in the DPVL mode when the signal is determined to be a DPVL signal or in the raster video mode when the signal is determined not to be a DPVL signal.

According to an aspect of the present invention, the display controller determines whether the input signal is a DPVL signal on the basis of a synchronous signal and a VBP signal of the input signal, and also determines whether the input signal is a DPVL signal on the basis of the decoded data of the input signal when the input signal is determined as a raster video signal.

According to an aspect of the present invention, the display apparatus further comprises a user selection part, wherein the display controller controls the display apparatus to operate either in the DPVL mode or in the raster video mode selected by a user through the user selection part, regardless of the synchronous signal and the VBP signal of the input signal.

According to an aspect of the present invention, the display apparatus further comprises a display module, wherein the display controller controls the display module to display an on-screen display (OSD) selection menu about a mode thereon when a user selects a menu about the mode through the user selection part.

According to an aspect of the present invention, the display apparatus further comprises a display module, wherein the display controller comprises an OSD generator generating a selection menu comprising operating mode information related to at least one of the DPVL mode and the raster mode, and controls the display apparatus to operate in at least one of the DPVL mode and the raster mode corresponding to operating mode information selected in the selection menu via the user selection part.

According to an aspect of the present invention, the display apparatus further comprises a display module, and a storage to store information about the DPVL mode and the raster video mode, wherein the display controller controls the display module to output the information related to a current operating mode of the display apparatus, which is stored in the storage.

According to an aspect of the present invention, the display apparatus further comprises a user selection part, wherein the display controller controls the display apparatus to operate either in the DPVL mode or in the raster video mode selected by a user through the user selection part, regardless of the decoded data of the signal input through the interface.

The foregoing and/or other aspects of the present invention are achieved by providing a display apparatus comprising an interface to receive a signal from an external source, and operating either in a DPVL mode or a raster video mode, the display apparatus comprising a user selection part, and a display controller to control the display apparatus to operate either in the DPVL mode or in the raster video mode selected by a user through the user selection part.

The foregoing and/or other exemplary aspects of the present invention are achieved by providing a method of controlling a display apparatus comprising an interface to receive a signal from an external source, and either operating in a DPVL mode or a raster video mode. According to an exemplary implementations, the method comprises determining whether the signal input through the interface is a DPVL signal on the basis of a synchronous signal and a VBP signal of the input signal, controlling the display apparatus to operate in the DPVL mode when the input signal is determined to be a DPVL signal, determining again whether the input signal is a DPVL signal on the basis of decoded data of the input signal when the input signal is not initially determined to be a DPVL signal, controlling the display apparatus to operate in the DPVL mode when the input signal is determined to be a DPVL signal, and controlling the display apparatus to operate in the raster video mode when the input signal is not determined to be a DPVL signal.

According to an aspect of the present invention, the method further comprises setting information about a corresponding mode when a user selects either the DPVL mode or the raster video mode; and controlling the display apparatus to operate in the set operating mode regardless of the synchronous signal and the VBP signal of the input signal.

According to an aspect of the present invention, the method comprises determining whether there is an operating mode selected and set by a user.

According to an aspect of the present invention, the method comprises setting information about the DPVL mode and the raster video mode, and outputting the information about the determined operating mode while the display apparatus operates in the operating mode corresponding to determined results.

### BRIEF DESCRIPTION OF THE DRAWINGS

These and other exemplary aspects and advantages of the present invention will become apparent and more readily appreciated from the following description of the embodiments thereof, taken in conjunction with the accompany drawings in which like reference symbols indicate the same or similar components, and wherein:

FIG. 1 is a control flowchart for determining whether a signal is a DPVL signal in a conventional display apparatus;

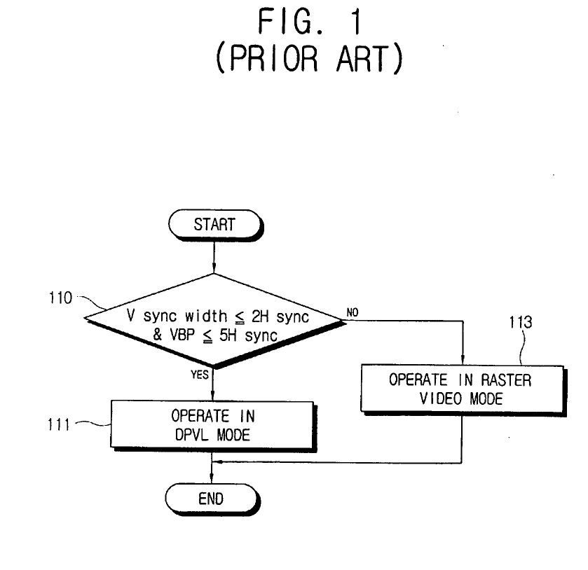

FIG. 2 is a control block diagram of a display apparatus according to an exemplary embodiment of the present invention;

FIG. 3 is a control flowchart for determining whether a signal is a DPVL signal or not in a display apparatus according to an exemplary embodiment of the present invention;

FIG. 4 is a control flowchart showing an exemplary implementation of a method according to an embodiment of the present invention;

FIG. 5 is a control flowchart showing an exemplary implementation of a method according to an embodiment of the present invention; and

FIG. 6 shows an OSD displayed in the display apparatus according to an embodiment of the present invention.

### DETAILED DESCRIPTION OF EXEMPLARY EMBODIMENTS

Reference will now be made in detail to the embodiments of the present invention, examples of which are illustrated in the accompanying drawings, wherein, as noted above, like reference numerals refer to like elements throughout. The embodiments are described below so as to explain exemplary implementations of the present invention by referring to the drawing figures.

A display apparatus according to an embodiment of the present invention supports digital packet video link (DPVL) standards of video electronics standard associations (VESA).

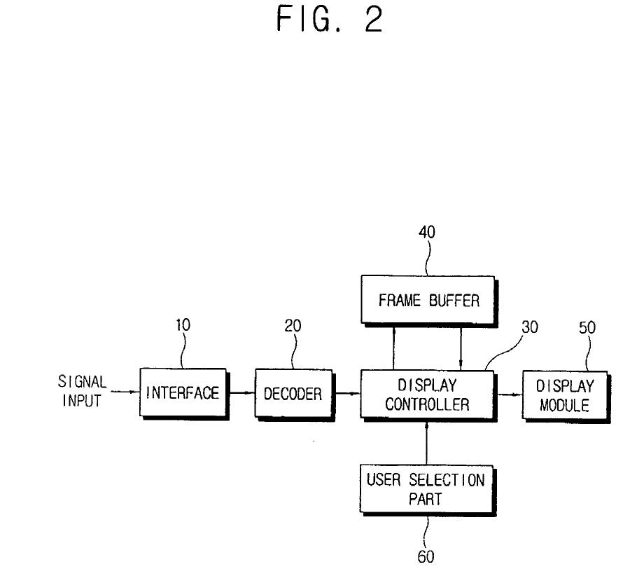

A display apparatus according to a first embodiment of the present invention will be described with reference to FIG. 2.

As shown in FIG. 2, the display apparatus according to the first embodiment of the present invention comprises an interface 10, a decoder 20, a display controller 30, a frame buffer 40, and a display module 50.

The interface 10 is connected with an external source and receives a signal from the external source. The interface 10 is capable of receiving a digital DPVL signal from the external source.

Further, the interface 10 supports an interactive communication channel to communicate with the external source. According to an embodiment of the present invention, the interface 10 supports at least one of a display data channel (DDC) and a universal serial bus (USB).

The decoder 20 coverts the signal input through the interface 10 into a signal to be processed by the display controller 30. According to the first embodiment of the present invention, the decoder 20 can vary according to formats of the input signal.

The display controller 30 determines whether or not the data decoded by the decoder 20 is a DPVL signal. The signal transmitted to the display controller 30 includes horizontal(H)/vertical(V) synchronous signals, a front porch signal, a back porch signal, and video data. The display controller 30 determines whether or not the input signal is a DPVL signal on the basis of the decoded results of the video data.

According to an exemplary implementation, the DPVL video data is transmitted as a packet. The DPVL video data comprises a DPVL body section containing video data corresponding to an update area changed from a previous frame, and a header containing information about the DPVL body section. Alternatively, the DPVL body section may contain no data, and the header may be divided into a basic header and an extended header according to contents, which are called a basic packet and an extended packet, respectively.

The display controller 30 determines whether or not the decoded data is DPVL data or not on the basis of the foregoing contents of the DPVL video data. When the decoded data is determined to be DPVL data, the display controller 30 operates in a DPVL mode.

In the DPVL mode, the display controller 30 controls the frame buffer 40 to store the video data corresponding to the update area of a current frame on the basis of information about the DPVL packet outputted from the decoder 20. Further, the display controller 30 reads the total video data stored in the frame buffer 40 and converts it to a format for the display module 50, thereby allowing the display module 50 to display a picture based on the total video data.

On the other hand, when the decoded data is not determined to be DPVL signal, the display controller 30 operates in a raster video mode. In the raster video mode, the display controller 30 stores the total video data output from the decoder 20 in the frame buffer 40. When the total video data is stored in the frame buffer 40, the display controller 30 reads the total video data from the frame buffer and converts it to have a format for the display module 50, thereby allowing the display module 50 to display a picture based on the total video data.

According to an exemplary implementation, the frame buffer 40 has a storage size large enough to store a video signal corresponding to one frame. Further, the frame buffer 40 satisfies the DPVL standards of VESA.

Further, the display module 50 processes the signal received from the display controller 30, and displays a picture based on the processed signal. The display module 50 comprises a display panel to display a picture thereon, and a panel driver to control the display panel to display a picture on the basis of the signal received from the display controller 30. According to the first embodiment of the present invention, the display module 50 comprises one of various display modules such as a digital light processing (DLP), a liquid crystal display (LCD), a plasma display panel (PDP), and the like.

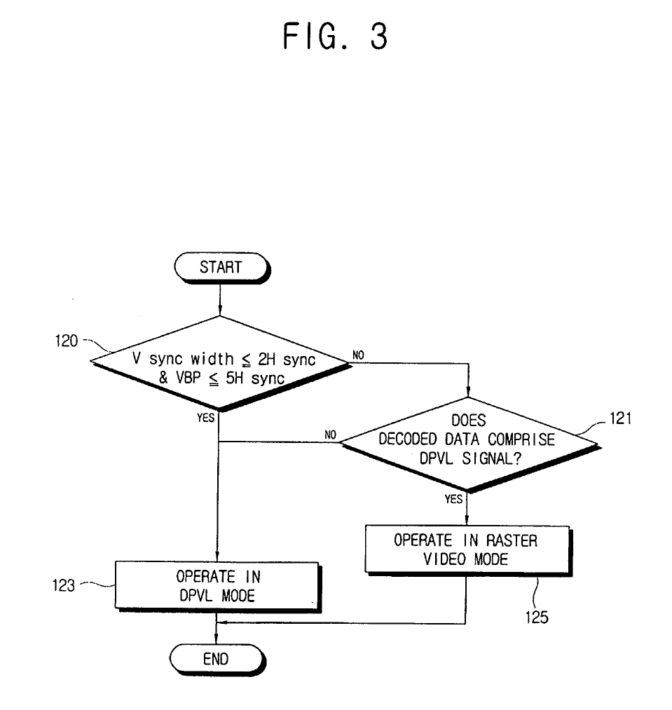

A display apparatus according to a second embodiment of the present invention will be described with reference to FIGS. 2 and 3.

The display apparatus according to the second embodiment of the present invention has similar configuration as that of the first embodiment, and repetitive descriptions will be avoided for conciseness.

The display controller 30 determines whether or not the input signal is the DPVL signal on the basis of the H/V synchronous signals and the vertical back porch (VBP) signal of the input signal. When the input signal is not determined as the DPVL signal, the display controller 30 determines again whether the input signal is the DPVL signal, by analyzing the decoded data.

An example of control operations of the display controller 30 is described below with reference to FIG. 3.

Referring to FIG. 3, at operation 120, the display controller 30 determines whether the input signal is a DPVL signal on the basis of the H/V synchronous signals and the VBP signal of the input signal.

According to the DPVL standards of VESA, the input signal is determined to be a DPVL signal when the input signal satisfies the following conditions:
V-sync width≦2H-sync
VBP≦5H-sync <Equation 1>

In other words, when the input signal has the width of the vertical synchronous signal that is equal to or smaller than a period corresponding to two horizontal lines, and the VBP signal is equal to or smaller than a period corresponding to five horizontal lines, this frame data is determined to be a DPVL signal.

When the input signal is determined to be a DPVL signal, at operation 123, the display apparatus operates in the DPVL mode. In the DPVL mode, the display controller 30 analyzes the DPVL data, and controls the current frame buffer 40 to store the DPVL data in a corresponding address thereof. When the DPVL data is completely stored in the frame buffer 40, the display controller 30 reads the total data stored in the frame buffer 40, and controls the display module 50 to display a picture based on the read total data.

On the other hand, when the input signal is not determined to be a DPVL signal, at operation 121, the display controller 30 determines again whether the input signal can be decoded by the decoder 20 as a DPVL signal. Then, when the data decoded by the decoder 20 has the properties of the DPVL data, at operation 123, the display controller 30 determines the input signal as the DPVL signal and operates in the DPVL mode. Otherwise, at operation 125, the display controller 30 operates in the raster video mode.

Thus, even though the input signal is not initially determined to be a DPVL signal on the basis of the H/V synchronous signals and the VBP signal of the input signal, the input signal is analyzed once more to determine whether or not it is a DPVL signal on the basis of the decoded result. Therefore, even though the display apparatus receives an abnormal DPVL signal, the display apparatus operates in the DPVL mode, and normally displays a picture based on the abnormal DPVL signal.

An exemplary implementation of a display apparatus according to a third embodiment of the present invention is described below with reference to FIGS. 2, 4 and 6(A). The display apparatus according to the third embodiment of the present invention further comprises a user selection part 60 as shown in FIG. 2.

The user selection part 60 allows a user to select the DPVL mode. According to an exemplary implementation, the user selection part 60 can be achieved by a button, a key, a touch pad, an on screen display (OSD) generator, and the like, which are provided in the display apparatus. Further, the user selection part 60 can be achieved by a graphic user interface (GUI) provided from the external source, a key board, and the like.

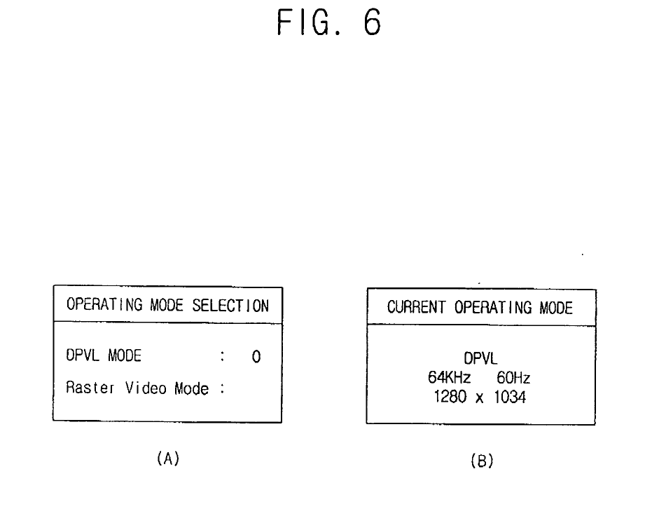

When a user selects a predetermined key through the user selection part 60, as shown in FIG. 6(A), the display controller 30 controls the display module 50 to display a picture for allowing a user to select an operation mode. At this time, a user can select the operation mode through the user selection part 60, and the display controller 30 is set to operate in the operation mode selected through the user selection part 60.

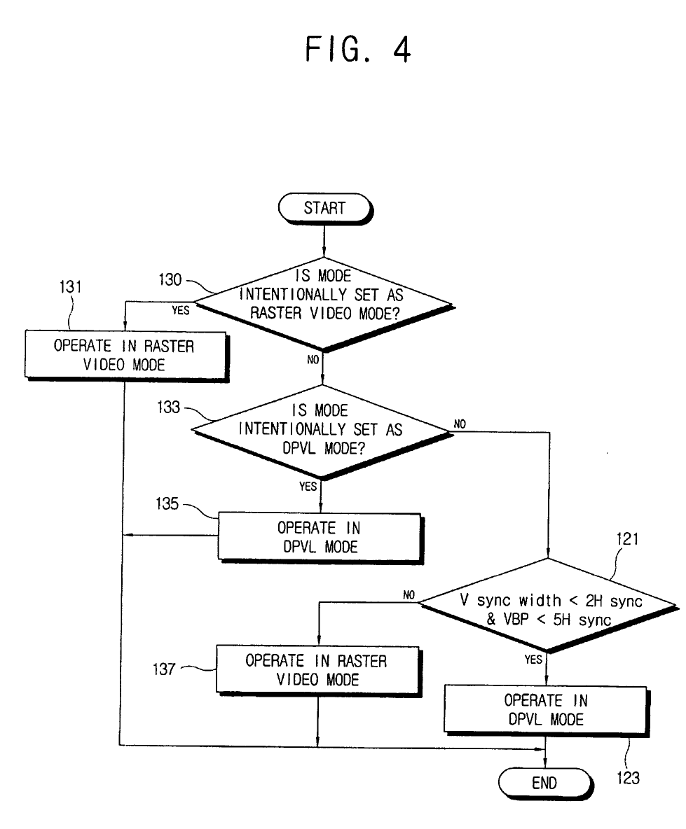

An example of a control flowchart of the display apparatus as described above is shown in FIG. 4.

Referring to FIG. 4, when the signal is input to the display apparatus, at operation 130, the display controller 30 determines whether it is intentionally set as the raster video mode through the user selection part 60. In the case that the display controller 30 is intentionally set as the raster video mode, at operation 131, the display controller 30 operates in the raster video mode.

In the case that the display controller 30 is not set as the raster video mode, at operation 133, the display controller 30 determines whether it is intentionally set as the DPVL mode. In the case that the display controller 30 is intentionally set as the DPVL mode, at operation 135, the display controller 30 operates in the DPVL mode.

On the other hand, in the case that the display controller 30 is not previously set through the user selection part 60, at operation 120, the display controller 30 determines whether the input signal is a DPVL signal on the basis of the H/V synchronous signals and the VBP signal of the input signal, and operates in the DPVL mode (at operation 123) or in the raster video mode (at operation 137) according to the determined results.

Thus, when there is an operation mode selected and set by a user, the display controller 30 operates regardless of the input signals in the operation mode selected and set by a user.

An exemplary implementation of a display apparatus according to a fourth embodiment of the present invention is described below with reference to FIGS. 2, 5 and 6(B).

The display controller 30 determines whether or not the input signal is a DPVL signal, and controls the determined results to be displayed as shown in FIG. 6(B).

For example, FIG. 6(B) illustrates a case where the input signal is determined to be a DPVL signal. In this case, corresponding information is represented as DPVL, 64 KHz, 60 Hz, 1280×1034, or the like.

Hence, a user is allowed to know what kind of signal is currently input.

In the fourth embodiment, the display controller 30 also determines whether the input signal is a DPVL signal as described above.

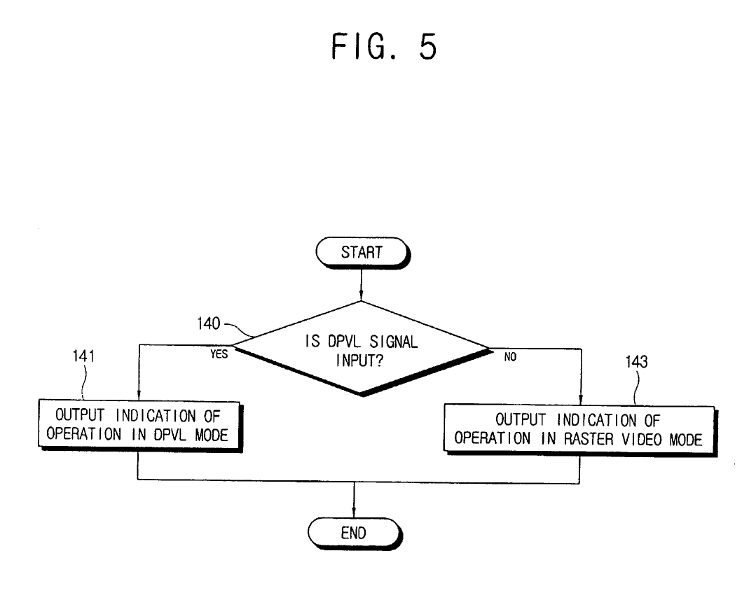

As shown in FIG. 5, at operation 140, the display controller 30 determines whether or not the input signal is a DPVL signal. When the input signal is determined to be a DPVL signal, at operation 141, the display controller 30 operates in the DPVL mode, and outputs information about the DPVL mode. When the input signal is not determined to be a DPVL signal, at operation 143, the display controller 30 operates in the raster video mode, and outputs information about the raster video mode.

As described above, exemplary embodiments of the present invention provide a display apparatus and a control method thereof, where it is determined whether or not the input signal is a DPVL signal on the basis of decoded results of the input data, thereby displaying a picture normally based even on an abnormal DPVL signal.

Although exemplary embodiments of the present invention have been shown and described, it will be appreciated by those skilled in the art that various changes and modifications may be made in these embodiments without departing from the principles and spirit of the invention, the scope of which is defined in the appended claims and their equivalents.

What is claimed is:

1. A display apparatus which receives a signal from an external source, and operates in at least one of a digital packet video link (DPVL) mode and a raster video mode, the display apparatus comprising:
a decoder for decoding data of an input signal; and
a display controller for determining whether the input signal comprises a DPVL signal on the basis of the decoded data, and for controlling the display apparatus to operate in at least one of a DPVL mode when the input signal comprises a DPVL signal and a raster video mode when the input signal does not comprise a DPVL signal.

2. The display apparatus according to claim 1, wherein the display controller performs a first determination of whether the input signal comprises a DPVL signal on the basis of a synchronous signal and a VBP signal of the input signal, and performs a second determination of whether the input signal comprises a DPVL signal on the basis of the decoded data of the input signal when the input signal is determined to comprise a raster video signal in the first determination.

3. The display apparatus according to claim 2, further comprising a user selection part,
wherein the display controller controls the display apparatus to operate in at least one of the DPVL mode and the raster video mode selected via the user selection part.

4. The display apparatus according to claim 3, further comprising a display module,
wherein the display controller comprises an on-screen display (OSD) generator generating a selection menu comprising operating mode information related to at least one of the DPVL mode and the raster mode, and controls the display apparatus to operate in at least one of the DPVL mode and the raster mode corresponding to operating mode information selected in the selection menu via the user selection part.

5. The display apparatus according to claim 2, further comprising:
a display module; and
a storage for storing operating mode information of the display apparatus, the operating mode information comprising information related to at least one of the DPVL mode and the raster video mode;
wherein the display controller controls the display module to output the operating mode information.

6. The display apparatus according to claim 1, further comprising a user selection part,
wherein the display controller controls the display apparatus to operate in at least one of the DPVL mode and the raster video mode selected via the user selection part.

7. The display apparatus according to claim 6, further comprising a display module,
wherein the display controller comprises an on-screen display (OSD) generator generating a selection menu comprising operating mode information related to at least one of the DPVL mode and the raster mode, and controls the display apparatus to operate in at least one of the DPVL mode and the raster mode corresponding to operating mode information selected in the selection menu via the user selection part.

8. The display apparatus according to claim 1, further comprising:
a display module; and
a storage for storing operating mode information of the display apparatus, the operating mode information comprising information related to at least one of the DPVL mode and the raster video mode,
wherein the display controller controls the display module to output the operating mode information.

9. A display apparatus which receives a signal from an external source, and operates in at least one of a digital packet video link (DPVL) mode and a raster video mode, the display apparatus comprising:
a user selection part; and
a display controller for controlling the display apparatus to operate in the at least one of the DPVL mode and the raster video mode selected via the user selection part.

10. A method of controlling a display apparatus which receives a signal from an external source, and operates in at least one of a digital packet video link (DPVL) mode and a raster video mode, the method comprising:
initially determining whether an input signal comprises a DPVL signal on the basis of a synchronous signal and a VBP signal of the input signal;
controlling the display apparatus to operate in the DPVL mode when the input signal is determined to comprise the DPVL signal;
subsequently determining whether the input signal comprises the DPVL signal on the basis of decoded data of the input signal when the input signal is not determined to comprise a DPVL signal in the initial determination;
controlling the display apparatus to operate in the DPVL mode when the input signal is determined to comprise a DPVL signal in the subsequent determination; and
controlling the display apparatus to operate in the raster video mode when the input signal is determined not to comprise a DPVL signal in the subsequent determination.

11. The method according to claim 10, further comprising:
setting operating mode information related to at least one of the DPVL mode and the raster video mode when the at least one of the DPVL mode and the raster video mode is selected; and
controlling the display apparatus to operate in the at least one of the DPVL mode and the raster video mode based on the setting of the operating mode information.

12. The method according to claim 11, further comprising determining whether the operating mode information comprises a user selected operating mode information.

13. The method according to claim 10, further comprising:
setting operating mode information, the operating mode information comprising information related to at least one of the DPVL mode and the raster video mode; and
outputting the operating mode information while the display apparatus operates in the at least one of the DPVL mode and the raster video mode.
